(19) United States
(12) Patent Application Publication
(10) Pub. No.: US 2025/0354911 A1
(43) Pub. Date: Nov. 20, 2025

(54) PARTICLE ANALYSIS DEVICE, PARTICLE ANALYSIS SYSTEM, AND PARTICLE ANALYSIS METHOD

(71) Applicant: Mitsubishi Electric Corporation, Tokyo (JP)

(72) Inventor: Kazuki SHIGYO, Tokyo (JP)

(73) Assignee: Mitsubishi Electric Corporation, Tokyo (JP)

(21) Appl. No.: 19/281,871

(22) Filed: Jul. 28, 2025

Related U.S. Application Data
(63) Continuation of application No. PCT/JP2023/009737, filed on Mar. 14, 2023.

(51) Int. Cl. G01N 15/1434; G01N 15/10; G01N 15/1429

(52) U.S. Cl. CPC G01N 15/1436; G01N 15/1429; G01N 2015/1021; G01N 2015/1029; G01N 2015/144

(57) ABSTRACT

A particle analysis device includes: an acquiring unit to acquire a multi-viewpoint image obtained by synthesizing captured images of a lens array on which an image of light from a particle irradiated with light are formed via a main lens, the captured images being captured simultaneously from mutually different viewpoints by a plurality of cameras; a sensing unit to sense a light intensity pattern of scattered light scattered from the particle on the basis of the multi-viewpoint image acquired; an analyzing unit to analyze a scattering solid angle of scattered light relative to an optical axis of the main lens as a center on the basis of the light intensity pattern of the scattered light sensed; and a calculating unit to calculate a molecular weight and particle size of the particle on the basis of the scattering solid angle of the scattered light analyzed.

### CROSS REFERENCE TO RELATED APPLICATION

This application is a Continuation of PCT International Application No. PCT/JP2023/009737, filed on Mar. 14, 2023, which is hereby expressly incorporated by reference into the present application.

### TECHNICAL FIELD

The present disclosure relates to a particle analysis device, a particle analysis system, and a particle analysis method.

### BACKGROUND ART

Conventionally, a particle analysis device has been provided. The particle analysis device irradiates analysis-target particles with light, and analyzes optical characteristics of the particles on the basis of scattered light generated by the irradiation. For example, such a conventional particle analysis device is disclosed in Patent Literature 1.

### CITATION LIST

### Patent Literature

Patent Literature 1: JP 2020-122717 A

### SUMMARY OF INVENTION

### Technical Problem

The particle analysis device disclosed in Patent Literature 1 captures and observes images of the brightness distribution and scattering angle distribution of scattered light from scatterer particles. In a case where the particle analysis device disclosed in Patent Literature 1 is used to analyze the three-dimensional structure of particles, images of an optical system in which an image of light from a subject is formed need to be sequentially captured from a plurality of mutually different viewpoints. Because of this, there is a fear that a long time is required from image-capturing until analysis.

The present disclosure has been made to solve the problem described above, and an object thereof is to provide a particle analysis device that can three-dimensionally analyze a scatterer particle by performing image-capturing only once.

### Solution to Problem

A particle analysis device according to the present disclosure includes: acquiring circuitry to acquire a multi-viewpoint image obtained by synthesizing captured images of a lens array on which an image of light from a particle irradiated with light is formed via a main lens, the captured images being captured simultaneously from mutually different viewpoints by a plurality of cameras; sensing circuitry to sense a light intensity pattern of scattered light scattered from the particle on the basis of the multi-viewpoint image acquired by the acquiring circuitry; analyzing circuitry to analyze a scattering solid angle of scattered light relative to an optical axis of the main lens as a center on the basis of the light intensity pattern of the scattered light sensed by the sensing circuitry; and calculating circuitry to calculate a molecular weight and particle size of the particle on the basis of the scattering solid angle of the scattered light analyzed by the analyzing circuitry.

### Advantageous Effects of Invention

According to the present disclosure, it is possible to three-dimensionally analyze a scatterer particle by performing image-capturing only once.

### BRIEF DESCRIPTION OF DRAWINGS

FIG. 1 is a schematic diagram illustrating the configuration of a particle analysis system according to a first embodiment.

FIG. 2 is a block diagram illustrating the configuration of a particle analysis device according to the first embodiment.

FIG. 3 is a flowchart illustrating a particle analysis method according to the first embodiment.

FIGS. 4A and 4B are drawings illustrating multi-viewpoint images. FIG. 4A is a multi-viewpoint image in a case where an image of light from a main lens is formed on each lens of a lens array. FIG. 4B is a multi-viewpoint image in a case where an image of light from the main lens is formed before/behind the lens array.

FIG. 5 is a drawing in which the scattering solid angle of scattered light and a minimum encompassing circle are associated with each other.

FIGS. 6A and 6B are drawings illustrating a multi-viewpoint image including the diffraction pattern of diffracted light. FIG. 6A is a drawing illustrating a main lens image. FIG. 6B is an enlarged view of FIG. 6A.

FIGS. 7A and 7B are drawings illustrating examples of the hardware configuration of the particle analysis device according to the first embodiment.

### DESCRIPTION OF EMBODIMENTS

Hereinafter, a mode for implementing the present disclosure is explained with reference to the attached drawings in order to explain the present disclosure in more detail.

### First Embodiment

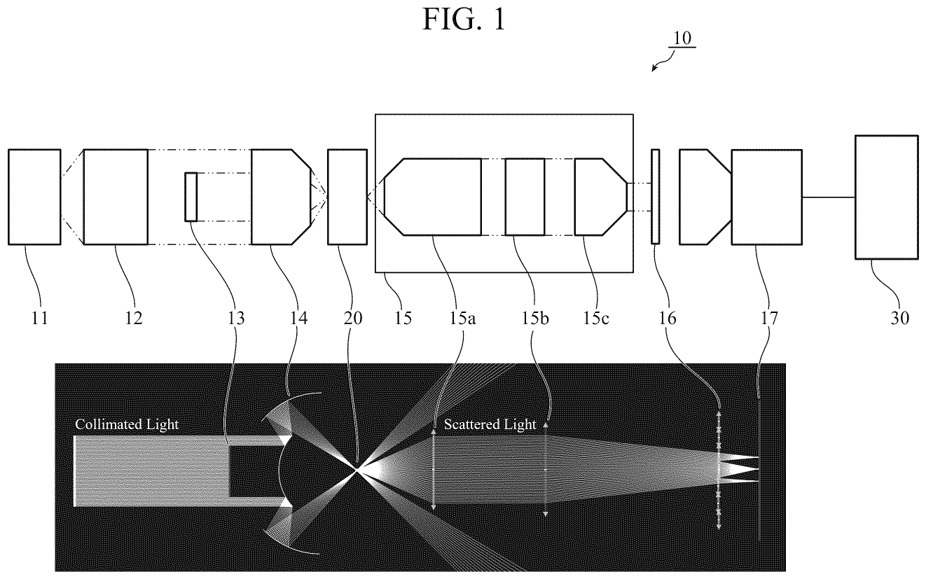

First, the configuration of a particle analysis system 10 according to a first embodiment is explained using FIG. 1. FIG. 1 is a schematic diagram illustrating the configuration of the particle analysis system 10 according to the first embodiment. Note that the upper drawing in FIG. 1 illustrates the configuration of the particle analysis system 10. In addition, the lower drawing in FIG. 1 illustrates a geometrical optics simulation corresponding to the particle analysis system 10.

As illustrated in FIG. 1, the particle analysis system 10 includes a light source 11, a collimator lens 12, a blocking plate 13, a condenser lens 14, a main lens 15, a lens array 16, a plurality of cameras 17, and a particle analysis device 30. In addition, in the particle analysis system 10, a sample 20 can be attached between the condenser lens 14 and the main lens 15. The sample 20 includes a material that can transmit light. The light source 11, the collimator lens 12, the blocking plate 13, the condenser lens 14, and the lens array 16 are arranged coaxially on the optical axis of the main lens 15.

The light source 11 radially outputs light from its leading end. The light source 11 can adjust the wavelength and intensity of the light to be output. For example, the light source 11 is a laser light source to output laser light.

The collimator lens 12 includes a plurality of circular lenses. The collimator lens 12 transmits the radial light output from the light source 11, thereby converting the radial light into collimated light, and outputting the collimated light.

The blocking plate 13 is formed in a disk shape. The blocking plate 13 is disposed between the collimator lens 12 and the condenser lens 14. In addition, the diameter of the blocking plate 13 is smaller than the lens diameter of the collimator lens 12 and the lens diameter of the condenser lens 14. Because of this, the blocking plate 13 blocks the central portion of the collimated light output from the collimator lens 12, thereby shaping the collimated light into collimated light without light of the central portion.

The condenser lens 14 transmits the collimated light without the central portion shaped by the blocking plate 13, thereby converting the collimated light into conical light without the central portion, and outputting the conical light. That is, the conical light without the central portion is light with such a tapered shape that the diameter of the light gradually decreases from the condenser lens 14 toward the sample 20. At this time, the central portion of the conical light also is conical. Such conical light output from the condenser lens 14 is radiated onto the sample 20. Note that the blocking plate 13 and the condenser lens 14 are included in a dark field-of-view condenser lens.

Here, when particles forming the sample 20 are irradiated with the conical light described above, one or more particles irradiated with the conical light generate light scattering. Hereinafter, particles that have scattered light are referred to as scatterers. At this time, in a case where the light output from the light source 11 is laser light interfered with the blocking plate 13, scatterer particles generate scattered light that is scattered forward toward the main lens 15, and diffracted light generated by diffraction, in some cases. Because of this, the scattered light and the diffracted light generated by the scatterers are incident on the main lens 15 mentioned later.

The main lens 15 transmits the scattered light scattered from the scatterers and the diffracted light diffracted by the scatterers, and causes images of the light to be formed on the lens array 16 mentioned later. For example, the main lens 15 includes an objective lens 15a and an image-formation lens 15b. Alternatively, the main lens 15 includes a microlens 15c. The objective lens 15a and the image-formation lens 15b are arranged in this order from the side of the sample 20 toward the side of the lens array 16.

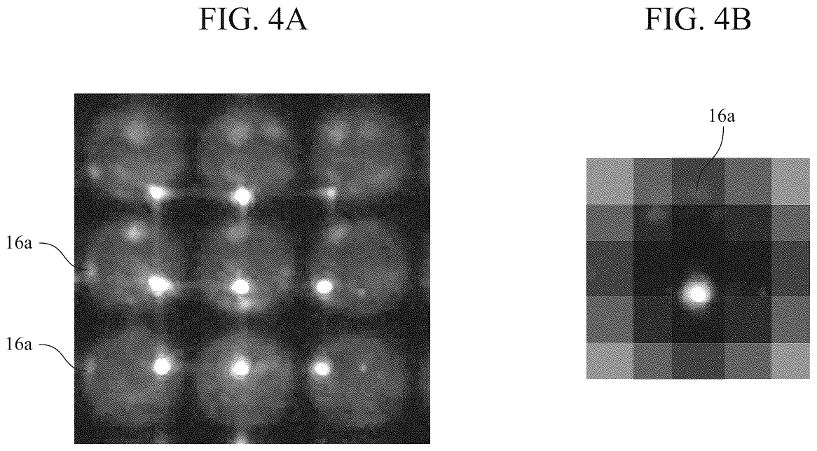

The lens array 16 includes a plurality of lenses 16a (see FIG. 4A). These lenses 16a are arranged at constant pitches or arranged at random pitches.

The plurality of cameras 17 have image-capturing areas which are areas including all the lenses 16a of the lens array 16, and capture images of light formed on each lens 16a. Note that, in the particle analysis system 10 illustrated in FIG. 1, one camera 17 is illustrated as a representative one of the plurality of cameras 17. The cameras 17 are arranged at mutually different respective positions, and capture images of the surface of the lens array 16 from mutually different viewpoints or directions.

In addition, each camera 17 is connected to an image generating unit (illustration omitted). This image generating unit synthesizes all images simultaneously captured by the respective cameras 17, thereby generating a multi-viewpoint image like one obtained by capturing images of the lens array 16 from a plurality of viewpoints. Because of this, the multi-viewpoint image generated by the image generating unit is a three-dimensional image. Furthermore, the image generating unit is capable of outputting the generated multi-viewpoint image to the particle analysis device 30.

Furthermore, in a case where a captured lens array image is rotated and unaligned with the optical axis of an image sensor of a camera 17 as the rotation center, the camera 17 corrects the rotation angle of the lens array image.

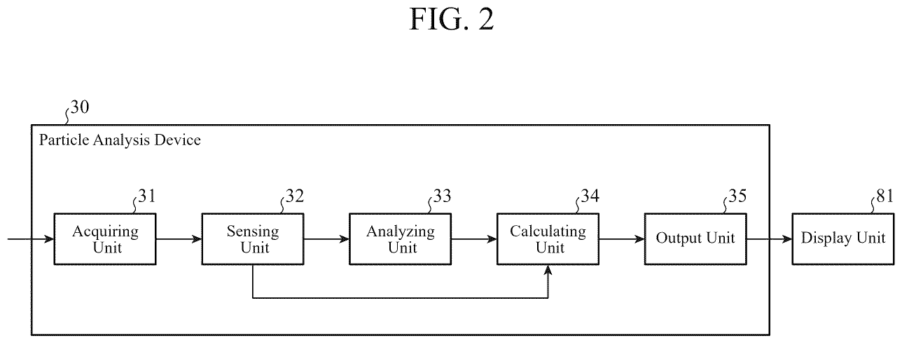

Next, the configuration of the particle analysis device 30 according to the first embodiment is explained using FIG. 2. FIG. 2 is a block diagram illustrating the configuration of the particle analysis device 30 according to the first embodiment.

As illustrated in FIG. 2, the particle analysis device 30 includes an acquiring unit 31, a sensing unit 32, an analyzing unit 33, a calculating unit 34, and an output unit 35.

The acquiring unit 31 acquires a multi-viewpoint image from the image generating unit connected to the plurality of cameras 17. The acquiring unit 31 outputs the acquired multi-viewpoint image to the sensing unit 32.

The sensing unit 32 acquires the multi-viewpoint image from the acquiring unit 31. On the basis of the acquired multi-viewpoint image, the sensing unit 32 senses the light intensity pattern of scattered light and the light intensity pattern of diffracted light. Each light intensity pattern is a three-dimensional light intensity pattern. The sensing unit 32 outputs, to the analyzing unit 33, the light intensity pattern of the scattered light and the light intensity pattern of the diffracted light which have been sensed.

In addition, the sensing unit 32 is capable of generating an image on any focal plane (hereinafter, referred to as a refocused image) from the multi-viewpoint image. A plurality of refocused images can be generated from one multi-viewpoint image; as a result, reproduction of a three-dimensional image is possible.

The analyzing unit 33 acquires the light intensity pattern of the scattered light and the light intensity pattern of the diffracted light from the sensing unit 32. The analyzing unit 33 analyzes the scattering solid angle of the scattered light on the basis of the light intensity pattern of the scattered light. In addition, the analyzing unit 33 analyzes the diffraction pattern of the diffracted light on the basis of the light intensity pattern of the diffracted light. The analyzing unit 33 outputs, to the calculating unit 34, the scattering solid angle of the scattered light and the analyzed diffraction pattern of the diffracted light which have been analyzed. Note that the scattering solid angle of the scattered light is the angle of emission or angle of inclination of the scattered light relative to the optical axis of the main lens 15 as the center.

The calculating unit 34 acquires the scattering solid angle of the scattered light and the diffraction pattern of the diffracted light from the analyzing unit 33. Using the scattering solid angle of the scattered light and known theories, the calculating unit 34 calculates the weight and radius of a corresponding scatterer particle. In addition, using the diffraction pattern of the diffracted light, the calculating unit 34 calculates the radius of the scatterer particle.

The calculating unit 34 outputs, to the output unit 35, the calculated weight and radius of the scatterer particle.

The output unit 35 acquires the weight and radius of the scatterer particle from the calculating unit 34. The output unit 35 outputs, to a display unit 41, the acquired weight and radius of the scatterer particle.

The display unit 41 acquires the weight and radius of the scatterer particle from the output unit 35. The display unit 41 displays, on a display screen, the acquired weight and radius of the scatterer particle.

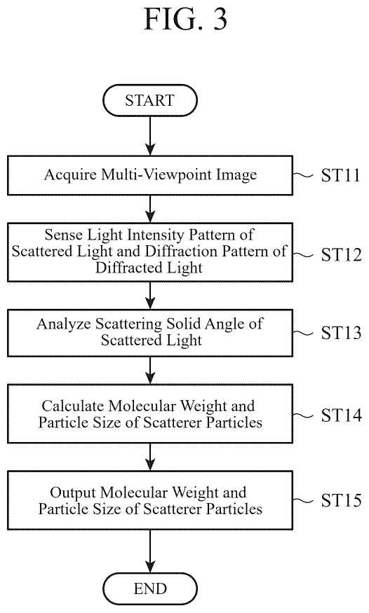

Next, a particle analysis method according to the first embodiment is explained using FIG. 3. FIG. 3 is a flowchart illustrating the particle analysis method according to the first embodiment.

At Step ST11, the acquiring unit 31 acquires a multi-viewpoint image obtained by synthesizing captured images simultaneously captured by the plurality of cameras 17.

At Step ST12, the sensing unit 32 senses the light intensity pattern of scattered light scattered from a scatterer particle, and the diffraction pattern of diffracted light diffracted by the scatterer particle.

At Step ST13, on the basis of the light intensity pattern of the scattered light, the analyzing unit 33 analyzes the scattering solid angle of the scattered light relative to the optical axis of the main lens 15 as the center.

At Step ST14, on the basis of the scattering solid angle of the scattered light, the calculating unit 34 calculates the molecular weight and particle size of the scatterer particle. In addition, on the basis of the diffraction pattern of the diffracted light, the calculating unit 34 calculates the particle size of the scatterer particle.

At Step ST15, the output unit 35 outputs, to the display unit 41, the molecular weight and particle size of the scatterer particle.

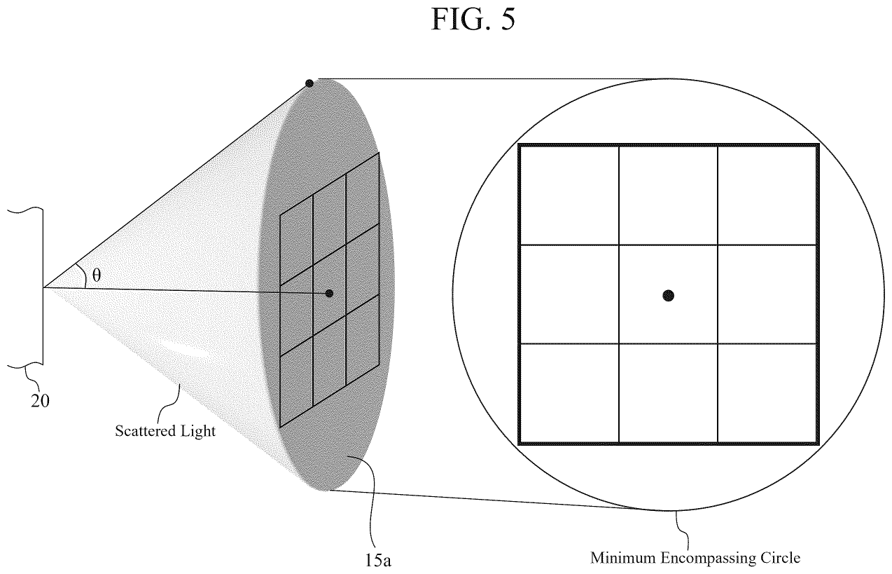

Next, analysis of scattered light is explained in detail using FIGS. 4A and 4B, and FIG. 5. FIGS. 4A and 4B are drawings illustrating multi-viewpoint captured images. FIG. 5 is a drawing in which the scattering solid angle of scattered light and a minimum encompassing circle are associated with each other.

FIG. 4A is a multi-viewpoint image in a case where an image of light from the main lens 15 is formed on each lens 16a of the lens array 16. The bright spot portion of each lens 16a is in focus, and can be seen clearly. FIG. 4B is a multi-viewpoint image in a case where an image of light from the main lens 15 is formed before/behind the lens array 16. The bright spot portion of the lens 16a is out of focus, and is blurred. Note that FIG. 4A illustrates an enlarged view of nine lenses 16a obtained from the multi-viewpoint image. In addition, FIG. 4B is an enlarge view of one lens 16a obtained from the multi-viewpoint image.

In FIG. 4A and FIG. 4B, white areas are signal areas on which light is incident. In addition, black areas are noise areas on which light is not incident. Because of this, the sensing unit 32 can make distinctions between signal areas which are white areas and noise areas which are black areas on a multi-viewpoint image.

When an image is captured using the lens array 16, light scattered from the same scatterer is incident on the plurality of lenses 16a in some cases. The light incident on the lenses 16a is the respective results of observation of the scatterer from mutually different viewpoints, and scattered light obtained from mutually different scattering solid angles needs to be identified as bright spots obtained from the same scatterer in terms of analysis.

Depending on the array of particles, scattered light whose images are formed on the lens array 16, and light whose images are formed before/behind the lens array 16 are projected onto the same lens array 16, and observed, in some cases. In this case, the sensing unit 32 needs to separate integrated light of those pieces of light into the light intensity pattern of light incident from each scatterer.

For example, in a case where the light intensity pattern of scattered light is sensed using the multi-viewpoint image illustrated in FIG. 4A, the sensing unit 32 subtracts the difference between the average brightness of the average of the brightness of bright spot portions of the respective lenses 16a and the brightness of a bright spot portion from a pixel corresponding to the bright spot portion. In addition, in a case where the light intensity pattern of scattered light is determined using the multi-viewpoint image illustrated in FIG. 4B, the sensing unit 32 subtracts the average brightness from the light intensity pattern of a bright spot portion of each lens 16a.

In addition, the sensing unit 32 performs identification of a scatterer particle on the basis of, for example, the inter-lens pitch of the lens array 16, and the distance from the sample 20 to the objective lens 15a.

Here, in a case where, after the identification of the particle is performed, there is a particle that generates scattered light from a particular focal plane positioned on the optical axis of the objective lens 15a, as illustrated in FIG. 4A, the scattered light is projected onto the lens array 16 at particular intervals. Such a condition is equivalent to extraction of conical scattered light as illustrated in FIG. 5. In addition, the scattered light is the same as light acquired by the objective lens 15a. 0 illustrated in FIG. 5 is the scattering solid angle of scattered light.

For calculation of the XY coordinates of target scatterers from such a lens array image including a plurality of bright spot portions, as illustrated in FIG. 5, the analyzing unit 33 needs to calculate the center of a minimum encompassing circle encompassed by light projected onto the lens array 16 and sensed from a plurality of identical scatterers.

In a case where the distances among scatterers inside the sample 20 are short, bright spot portions of scattered light are generated on some lenses 16a in the lens array 16. At this time, a minimum encompassing circle defined for a predetermined scatterer encompasses a bright spot portion corresponding to the scatterer. Because of this, by identifying a scatterer particle, a minimum encompassing circle can be drawn for the particle.

Then, the analyzing unit 33 analyzes the dependency of the scattering solid angle of scattered light on the basis of the barycentric coordinates of a bright spot portion obtained from the same particle included in a minimum encompassing circle as measured with the center of the minimum encompassing circle as the origin, the diameter of the main lens 15, and the like.

Next, the calculating unit 34 calculates the molecular weight and particle size of the scatterer particle using the scattering solid angle dependency of the scattered light analyzed by the analyzing unit 33, and a theoretical formula related to angle dependency obtained from the Mie scattering theory, which is a known theory. Note that information about a bright spot portion corresponding to each scattering solid angle can be converted into the molecular weight of a corresponding particle using the Mie scattering theory.

The following explains the point that the scattering solid angle dependency of scattered light of a particular pixel after generation of a refocused image can be analyzed from a ray overlapping matrix used for the generation of the refocused image.

The ray overlapping matrix can be created using the following Formula (1).

$$Δ = MLP ( 1 - fmla / ( d * M 2 - a ) ) \qquad ( 1 )$$

Δ: The distance between the same ray of light in the X-axis and Y-axis directions in a multi-viewpoint image
MLP: The pitch of the lenses 16a
d: The z-axis direction position where image-formation is desired (the distance from the object-side focal plane of the main lens 15 to a particle)
fmla: The focal length on the lens array image side of the main lens 15
a: The distance from the focal plane on the lens array image side of the main lens 15 to the center of the lens array 16 in the thickness direction

It is sufficient if the ray overlapping matrix is converted using the following Formula (2).

$${Δ}_{EI} = Δ - ( MLP - {EI}_{one} ) \qquad ( 2 )$$

EIₒₙₑ: The length of one side of an elemental image array cut out as a square from the one main lens 15

The row direction of the ray overlapping matrix corresponds to row numbers and column numbers in overlapping elemental image arrays. Because of this, by applying the ray overlapping matrix to each of rows and columns in an elemental image array, index information about pixels to be superimposed can be extracted from the elemental image array in the end. The index information corresponds to EIA(i,j), which is the pixel value present in the i-th row of the j-th column of the elemental image array. In view of this, the pixel value R(u,v) present in the u-th row of the v-th column after generation of a refocused image is represented by the following Formula (3) using a ray overlapping matrix C. Note that C is a matrix including k rows from the first row to the k-th row where k is a positive integer, and including the maximum number of rows=the maximum number of columns of the refocused image.

$$R ( u , v ) = {\sum }_{l = 1}^{k} ElA \{ C ( 1 : k \vert C \neq 0 , u ) , C ( 1 : k \vert C \neq 0 , v ) \} \qquad ( 3 )$$

Here, C(1:k|C≠0,u), which is the first item of Formula (3), represents a column not including 0 in the row direction from among columns u in the ray overlapping matrix C.

The scattering solid angle dependency SA[ua,va] represents what type of angle dependency the pixel value (u,v) corresponding to a state after generation of a refocused image has. Because of this, a matrix is stored in a pixel corresponding to the scattering solid angle dependency SA[ua,va]. Accordingly, the scattering solid angle dependency SA[ua,va] has a matrix form different from those of typical matrices. For example, a matrix like SA[ua,va]=(1,2;3,4) is stored corresponding to particular ua and va. Taking these into consideration, the scattering solid angle dependency SA can be represented by the following Formula (4).

$$SA [ ua , va ] = EIA \{ C ( 1 : k \vert C \neq 0 , u ) , C ( 1 : k \vert C \neq 0 , v ) \} \qquad ( 4 )$$

In addition, in a case where the scattering solid angle dependency in the light intensity pattern of the scattered light is calculated from a pixel value obtained with each scattering solid angle as mentioned above, the analyzing unit 33 performs measurement while gradually changing the intensity of light of the light source 11 whose power level is kept equal to or lower than 1 mW, and calculates the scattering solid angle of the scattered light on the basis of calibration data at that time.

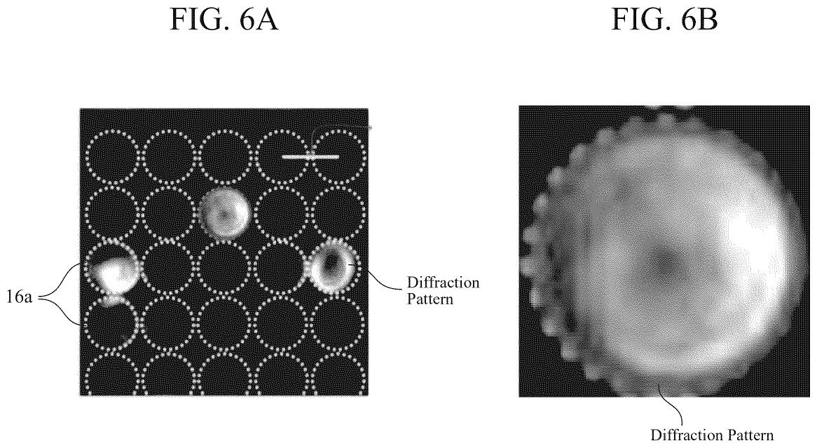

Next, analysis of diffracted light is explained using FIG. 6. FIG. 6 is a drawing illustrating a multi-viewpoint image including the diffraction pattern of diffracted light.

In a case where the particle size of a scatterer particle is smaller than the resolution of a multi-viewpoint image, it is difficult for the sensing unit 32 to sense the particle size of the scatterer particle on the basis of scattered light of the multi-viewpoint image. In this case, the sensing unit 32 senses the particle size of the scatterer particle using diffracted light of the multi-viewpoint image.

The diffraction pattern of the diffracted light is formed depending on the angle of incidence of the diffracted light relative to the lens array 16. The sensing unit 32 senses the diffraction pattern of the diffracted light using a refocused image generated from the multi-viewpoint image. The diffraction pattern on the object-side focal plane of the main lens 15 is projected directly onto the lens array 16. In addition, the diffraction patterns of non-focal planes other than the object-side focal plane can be acquired by reconstructing a focal plane on the side of target particle.

In addition, as illustrated in FIG. 6, the diffraction pattern of diffracted light diffracted by a scatterer is projected onto one lens 16a in the lens array 16 on the basis of the optical positional relationship between the focal plane of the main lens 15 and the lens array 16. From the diffraction pattern obtained from such a single particle, the calculating unit 34 calculates the particle size of the scatterer particle using Fraunhofer diffraction approximation.

The calculating unit 34 calculates the particle size of the scatterer particle using the following Formula (5). At this time, q is the radius of a first dark circular image of diffraction, R is the distance to a lens 16a where an observation image is formed, A is the wavelength of diffracted light, and D is the particle size of the particle.

$$q = 1.22 ( R * λ / D ) \qquad ( 5 )$$

Since the depth of focus of a typical observation system is shallow, R is the focal length of the objective lens 15a. In contrast, the calculating unit 34 extracts refocused images of mutually different focal planes from one multi-viewpoint image, and q is measured with each R using D as a fitting parameter. Accordingly, the particle size of the scatterer particle can be calculated precisely.

Note that the particle analysis device 30 according to the first embodiment is not aimed for analysis of reflection light from scatterer particles or transmitted light transmitted through scatterer particles. It becomes possible for the particle analysis device 30 to perform analysis when the reflection light or transmitted light described above is not incident on the main lens 15 and the lens array 16. Because of this, the particle analysis device 30 has a configuration which is significantly different from that of a device for analyzing the reflection light or transmitted light described above.

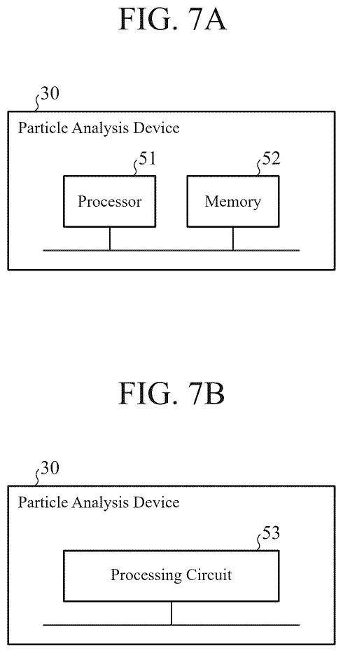

Next, hardware configuration examples of the particle analysis device 30 according to the first embodiment are explained using FIGS. 7A and 7B. FIGS. 7A and 7B are drawings illustrating examples of the hardware configuration of the particle analysis device 30 according to the first embodiment.

As illustrated in FIG. 7A, the particle analysis device 30 is configured using a computer, and the computer has a processor 51 and a memory 52. Programs for causing the computer to function as the acquiring unit 31, the sensing unit 32, the analyzing unit 33, the calculating unit 34, and the output unit 35 are stored on the memory 52. When the processor 51 reads out and executes the programs stored on the memory 52, the functions of the acquiring unit 31, the sensing unit 32, the analyzing unit 33, the calculating unit 34, and the output unit 35 are implemented.

Alternatively, as illustrated in FIG. 7B, the particle analysis device 30 may have a processing circuit 53. In this case, the processing circuit 53 may be implemented by the acquiring unit 31, the sensing unit 32, the analyzing unit 33, the calculating unit 34, and the output unit 35.

Alternatively, the particle analysis device 30 may have the processor 51, the memory 52, and the processing circuit 53 (not illustrated). In this case, some of the functions of the acquiring unit 31, the sensing unit 32, the analyzing unit 33, the calculating unit 34, and the output unit 35 may be implemented by the processor 51 and the memory 52, and the remaining functions may be implemented by the processing circuit 53.

For example, at least one of a Central Processing Unit (CPU), a Graphics Processing Unit (GPU), a microprocessor, a microcontroller, and a Digital Signal Processor (DSP) is used for the processor 51.

For example, at least one of a semiconductor memory and a magnetic disk is used for the memory 52. More specifically, at least one of a Random Access Memory (RAM), a Read Only Memory (ROM), a flash memory, an Erasable Programmable Read Only Memory (EPROM), an Electrically Erasable Programmable Read-Only Memory (EEPROM), a Solid State Drive (SSD), and a Hard Disk Drive (HDD) is used for the memory 52.

For example, at least one of an Application Specific Integrated Circuit (ASIC), a Programmable Logic Device (PLD), a Field-Programmable Gate Array (FPGA), a System-on-a-Chip (SoC), and a system Large-Scale Integration (LSI) is used for the processing circuit 53.

Note that, as mentioned above, the particle analysis device 30 according to the first embodiment calculates the molecular weight and particle size of a scatterer particle on the basis of the light intensity pattern of scattered light, and calculates the particle size of the scatterer particle on the basis of the diffraction pattern of diffracted light. In contrast, there are no problems even when the particle analysis device 30 calculates the molecular weight and particle size of a scatterer particle on the basis of the light intensity pattern of scattered light or calculates the particle size of a scatterer particle on the basis of the diffraction pattern of diffracted light.

In a case where the particle analysis device 30 calculates the molecular weight and particle size of a scatterer particle on the basis of the light intensity pattern of scattered light, it is sufficient if the particle analysis device 30 includes the acquiring unit 31, the sensing unit 32, the analyzing unit 33, the calculating unit 34, and the output unit 35. In addition, in a case where the particle analysis device 30 calculates the particle size of a scatterer particle on the basis of the diffraction pattern of diffracted light, it is sufficient if the particle analysis device 30 includes the acquiring unit 31, the sensing unit 32, the calculating unit 34, and the output unit 35.

As explained above, the particle analysis device 30 according to the first embodiment includes: the acquiring unit 31 to acquire a multi-viewpoint image obtained by synthesizing captured images of the lens array 16 on which an image of light from a particle irradiated with light is formed via the main lens 15, the captured images being captured simultaneously from mutually different viewpoints by the plurality of cameras 17; the sensing unit 32 to sense the light intensity pattern of scattered light scattered from the particle on the basis of the multi-viewpoint image acquired by the acquiring unit 31; the analyzing unit 33 to analyze the scattering solid angle of the scattered light relative to the optical axis of the main lens 15 as the center on the basis of the light intensity pattern of the scattered light sensed by the sensing unit 32; and the calculating unit 34 to calculate the molecular weight and particle size of the particle on the basis of the scattering solid angle of the scattered light analyzed by the analyzing unit 33. Because of this, the particle analysis device 30 can three-dimensionally analyze the scatterer particle by performing image-capturing only once.

In addition, the particle analysis device 30 according to the first embodiment includes: the acquiring unit 31 to acquire a multi-viewpoint image obtained by synthesizing captured images of the lens array 16 on which an image of light from a particle irradiated with light is formed via the main lens 15, the captured images being captured simultaneously from mutually different viewpoints by the plurality of cameras 17; the sensing unit 32 to sense the diffraction pattern of diffracted light diffracted by the particle on the basis of the multi-viewpoint image acquired by the acquiring unit 31; and the calculating unit 34 to calculate the particle size of the particle on the basis of the diffraction pattern of the diffracted light sensed by the sensing unit 32. Because of this, the particle analysis device 30 can three-dimensionally analyze the scatterer particle by performing image-capturing only once.

Note that, within the scope of the disclosure, modification of any constituent element according to an embodiment, or omission of any constituent element according to an embodiment is possible in the present disclosure.

### INDUSTRIAL APPLICABILITY

A particle analysis device according to the present disclosure can calculate the molecular weight and particle size of a scatterer particle on the basis of the light intensity pattern of scattered light and the diffraction pattern of diffracted light from a multi-viewpoint image. Accordingly, the particle analysis device can three-dimensionally analyze the scatterer particle by performing image-capturing only once, and is suited for being used for particle analysis devices and the like.

### REFERENCE SIGNS LIST

10: particle analysis system; 11: light source; 12: collimator lens; 13: blocking plate; 14: condenser lens; 15: main lens; 15a: objective lens; 15b: image-formation lens; 15c: microlens; 16: lens array; 16a: lens; 17: camera; 20: sample; 30: particle analysis device; 31: acquiring unit; 32: sensing unit; 33: analyzing unit; 34: calculating unit; 35: output unit; 41: display unit; 51: processor; 52: memory; 53: processing circuit

1. A particle analysis device comprising:
acquiring circuitry to acquire a multi-viewpoint image obtained by synthesizing captured images of a lens array on which an image of light from a particle irradiated with light is formed via a main lens, the captured images being captured simultaneously from mutually different viewpoints by a plurality of cameras;
sensing circuitry to sense a light intensity pattern of scattered light scattered from the particle on a basis of the multi-viewpoint image acquired by the acquiring circuitry;
analyzing circuitry to analyze a scattering solid angle of scattered light relative to an optical axis of the main lens as a center on a basis of the light intensity pattern of the scattered light sensed by the sensing circuitry; and
calculating circuitry to calculate a molecular weight and particle size of the particle on a basis of the scattering solid angle of the scattered light analyzed by the analyzing circuitry.

2. A particle analysis device comprising:
acquiring circuitry to acquire a multi-viewpoint image obtained by synthesizing captured images of a lens array on which an image of light from a particle irradiated with light is formed via a main lens, the captured images being captured simultaneously from mutually different viewpoints by a plurality of cameras;
sensing circuitry to sense a diffraction pattern of diffracted light diffracted by the particle on a basis of the multi-viewpoint image acquired by the acquiring circuitry; and
calculating circuitry to calculate particle size of the particle on a basis of the diffraction pattern of the diffracted light sensed by the sensing circuitry.

3. A particle analysis system comprising:
a light source to irradiate a sample including the particle with light;
the main lens to cause an image of light from the sample to be formed on the lens array;
the plurality of cameras to capture images of the lens array from mutually different viewpoints; and
the particle analysis device according to claim 1 connected to the plurality of cameras, wherein
the sample is disposed on an optical axis of the main lens, and disposed between the light source and the main lens.

4. A particle analysis system comprising:
a light source to irradiate a sample including the particle with light;
the main lens to cause an image of light from the sample to be formed on the lens array;
the plurality of cameras to capture images of the lens array from mutually different viewpoints; and
the particle analysis device according to claim 2 connected to the plurality of cameras, wherein
the sample is disposed on an optical axis of the main lens, and disposed between the light source and the main lens.

5. The particle analysis system according to claim 3, wherein
the particle analysis system comprises a dark field-of-view condenser lens to irradiate the sample with light output from the light source,
the light source and the dark field-of-view condenser lens are arranged on the optical axis of the main lens, and
the sample is disposed between the main lens and the dark field-of-view condenser lens.

6. The particle analysis system according to claim 4, wherein
the particle analysis system comprises a dark field-of-view condenser lens to irradiate the sample with light output from the light source,
the light source and the dark field-of-view condenser lens are arranged on the optical axis of the main lens, and
the sample is disposed between the main lens and the dark field-of-view condenser lens.

7. The particle analysis system according to claim 3, wherein the lens array includes a plurality of lenses arranged at constant pitches or a plurality of lenses arranged at random pitches.

8. The particle analysis system according to claim 4, wherein the lens array includes a plurality of lenses arranged at constant pitches or a plurality of lenses arranged at random pitches.

9. The particle analysis system according to claim 3, wherein the light source is capable of adjusting a wavelength and intensity of light to be output.

10. The particle analysis system according to claim 4, wherein the light source is capable of adjusting a wavelength and intensity of light to be output.

11. A particle analysis method comprising:
acquiring a multi-viewpoint image obtained by synthesizing captured images of a lens array on which an image of light from a particle irradiated with light is formed via a main lens, the captured images being captured simultaneously from mutually different viewpoints by a plurality of cameras;
sensing a light intensity pattern of scattered light scattered from the particle on a basis of the multi-viewpoint image acquired;
analyzing a scattering solid angle of scattered light relative to an optical axis of the main lens as a center on a basis of the light intensity pattern of the scattered light sensed; and
calculating a molecular weight and particle size of the particle on a basis of the scattering solid angle of the scattered light analyzed.

12. A particle analysis method comprising:
acquiring a multi-viewpoint image obtained by synthesizing captured images of a lens array on which an image of light from a particle irradiated with light is formed via a main lens, the captured images being captured simultaneously from mutually different viewpoints by a plurality of cameras;
sensing a diffraction pattern of diffracted light diffracted by the particle on a basis of the multi-viewpoint image acquired; and
calculating particle size of the particle on a basis of the diffraction pattern of the diffracted light sensed.
